(19) United States
(12) Patent Application Publication
(10) Pub. No.: US 2003/0006714 A1
(43) Pub. Date: Jan. 9, 2003

(54) Medical device having non-linear look-up table and medical image processing method therefor

(76) Inventor: Hyung-sik Choi, Goyang-city (KR)

Correspondence Address: NIXON & VANDERHYE, P.C., 8th Floor, 1100 North Glebe Road, Arlington, VA, 22201, US

(21) Appl. No.: 10/131,593

(22) Filed: Apr. 25, 2002

(30) Foreign Application Priority Data
Apr. 25, 2001 (KR) 2001-22352

(51) Int. Cl. G09G 3/10

(52) U.S. Cl. 315/169.3

(57) ABSTRACT

A medical device having a non-linear look-up table and a medical image processing method therefor, the method being used in a medical picture archival and communications system, are provided. The medical device has an image generating unit which generates the medical image; an image processing unit which receives the image signal, and processes the image to display the received signal; and a display unit which receives the output signal of the image processing unit and displays the signal, in which the image processing unit changes the values of the picture elements forming the image using a look-up table of which element values change according to the practitioner's manipulation. According to the device and method, a practitioner can more easily convert medical images and can diagnose a disease more accurately.

### BACKGROUND OF THE INVENTION

1. Field of the Invention

The present invention relates to a medical device, and more particularly, to a medical device having a non-linear look-up table and a medical image processing method therefor.

2. Description of the Related Art

In line with the development of electronic technologies, a new field of medical electronics is being highlighted, and a variety of medical devices, such as computerized tomography (CT) devices and magnetic resonance imaging (MRI) devices, have been introduced. With these devices, medical examinations or diagnoses that could not be done are now available and contribute to highly accurate diagnoses.

In the recent years, due to the fast development of diagnostic image devices, the role of diagnostic radiology departments have been rapidly extended. About 50˜70% of all patients visiting hospitals undergo medical examinations in the radiology departments and according to the results, appropriate remedies are provided.

As hospitals enlarge continuously and become more specialized and organized, issues such as how efficiently examinations and diagnosis based on medical images are performed and how fast opinions based on these analyses are transmitted to clinicians emerge as very important.

Along with the general growth of the image diagnosis field side effects such as image analysis, image storage and transmission, and the development of image diagnostic systems appear major tasks for the radiology departments. Delay in the work processes of the radiology department is attributed mostly to arranging and preparing films, patient information. According to the Medical Services Law of Korea, the film of a patient should be preserved for five years. Based on a recent survey, in a hospital having 1,000 beds, 200,000 through 500,000 medical pictures are taken every year, and this requires about 105.6 square meter floor space in storage facilities. Everyday, an average number of 645 interns spends about 45 minutes per film in processing the pictures. That is, a large amount of man-hours for processing storing and retrieving films and a place for storage are necessary, and delays due to the loss of pictures are inevitable. In addition, since the pictures can only be analyzed in the storage place, remote diagnosis is not available.

To solve this problem and provide quality services to patients, a medical Picture Archiving and Communications System (PACS) has been developed. As digital image apparatuses and digital diagnosis apparatuses are widely spreading, the need for the medical PACS systems is increasing. In order to store and transmit medical images, image data obtained in the form of an analog signal should be converted to a digital signal. Data conversion is carried out by a laser scanner or a scanner using a charge-coupled device (CCD).

Meanwhile, though medical PACS systems have been continuously developed, if a medical image is difficult to read and not diagnosable, prior art image processing apparatuses cannot substantially improve the quality of the medical image. Generally, image quality is the most important thing in image information.

Therefore, the development of a medical diagnosis device capable of substantially improving the image quality of an acquired and displayed medical image is strongly needed. Also, the development of an image storage and communication system for storing and communicating medical images having improved quality enabling accurate diagnosis is imperiously required.

### SUMMARY OF THE INVENTION

To solve the above problems, it is a first objective of the present invention to provide a medical diagnosis device for improving the image quality of an acquired and displayed medical image,

It is a second objective of the present invention to provide a method for image processing, the method being applied to an image storage and communications system

To accomplish the first objective of the present invention, there is provided a medical device for displaying medical images of a patient in order for a doctor to diagnose health condition of the patient, in which the medical device non-linearly converts the values of the picture elements forming the medical image by practitioner's manipulation and displays the converted image.

It is preferable that the medical device has an image generating unit which generates the medical image; an image processing unit which receives the image signal, and processes the image to display the received signal; and a display unit which receives the output signal of the image processing unit and displays the signal, in which the image processing unit changes the values of the picture elements forming the image using a look-up table of which element values change according to the practitioner's manipulation.

It is preferable that the medical device further has a storage module which stores the look-up table adaptively modified according to each part of the patient's body, in which a look-up table stored corresponding to each part of the patient's body is read and the image is processed.

To accomplish the second objective of the present invention, there is provided a medical image information processing method which is to be used in a medical picture archiving and communications system which stores medical images of a patient in a storage medium, and transmits the images to one or more terminals through a network, in which the values of picture elements forming the images are non-linearly converted by manipulation of the doctor and then are displayed.

It is preferable that the medical picture archiving and communications system has an image generating unit which generates the image; a transmitting unit which transmits the image through a network; and one or more terminals which receive and display the transmitted image, in which the image is displayed after the values of picture elements forming the image are changed using a look-up table of which member values change according to the practitioner's manipulation.

It is preferable that the medical picture archiving and communications system further has a storage module which stores look-up tables adaptively modified according to each part of the patient's body and the look-up tables stored corresponding to the part of the patient's body are read and the image is processed.

It is preferable that the image is generated by a computed radiography (CR) device.

### BRIEF DESCRIPTION OF THE DRAWINGS

The above objects and advantages of the present invention will become more apparent by describing in detail preferred embodiments thereof with reference to the attached drawings in which:

FIG. 1 is a block diagram of a medical device according to the present invention;

FIG. 2 is a block diagram of a medical picture archiving and communications system to which a medical image processing method according to the present invention is applied;

FIG. 3 is a diagram of a look-up table;

FIG. 4a shows a brain picture displayed by a medical device of the present invention;

FIG. 4b is a diagram of a look-up table used in displaying the brain picture shown in FIG. 4a;

FIG. 4c is a diagram of a modified version of the look-up table of FIG. 4a;

FIG. 4d shows a brain picture obtained by converting the brain picture shown in FIG. 4a using the look-up table shown in FIG. 4c;

FIG. 4e is a diagram for explaining a function for storing the look-up table shown in FIG. 4c;

FIG. 5a shows another brain picture displayed by a medical device according to the present invention;

FIG. 5b is a diagram for explaining a function for fetching a look-up table stored in FIG. 4e in order to apply the look-up table to the brain picture of FIG. 5a; and

FIG. 5c shows a brain picture obtained by converting the brain picture shown in FIG. 5a using the look-up table stored in FIG. 4e.

### DESCRIPTION OF THE PREFERRED EMBODIMENTS

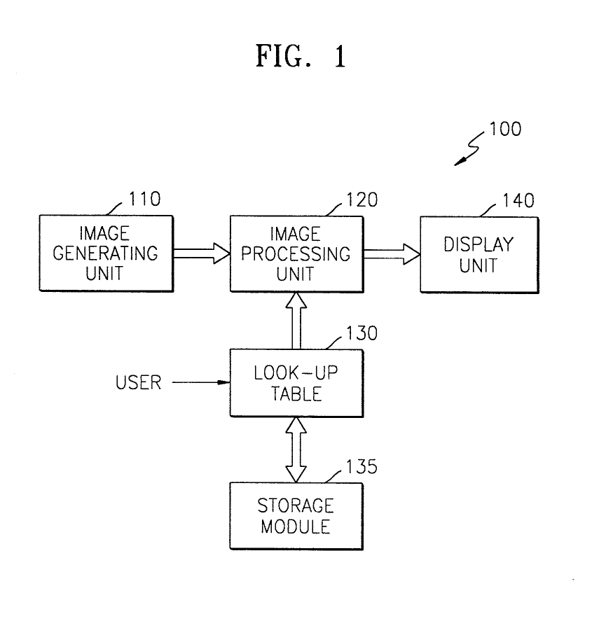

FIG. 1 is a block diagram of a medical device according to the present invention, which includes an image generating unit 110, an image processing unit 120, a look-up table 130, a display unit 140, and a storage module 135.

The image generating unit 110 acquires and generates an image of a part of the body of a patient. Images may be all kinds of medical images, such as a computed tomography (CT) picture or a magnetic resonance imaging (MRI) images of a predetermined part of a body.

For example, the image generating unit 110 may be an MRI device having a gantry (not shown), an operating console (not shown), and a computer (not shown). In this case, the gantry consists of a main magnet, a secondary magnet, and a radio frequency system. A resistive magnet or a superconducting electromagnet may be used as the main magnet; nowadays most hospitals use superconducting electromagnet. Also, the secondary magnet may include a shimming coil for uniform magnetic field intensity and a gradient coil for vortex compensation. The radio frequency system may include a frequency synthesizer, a radio frequency power amplifier, and a coupler. The structure and operating principle of the MRI device are well known to a person of ordinary skill in the art, and the structure of the MRI device is not related to the present invention. Any MRI device that can visualize and output the image of a predetermined part of the body of a patient may be employed. Therefore, a detailed explanation of the MRI device will be omitted.

As another example, the image generating unit 110 may be a CT device. In the medical field, CT devices are used to obtain in a nondestructive way, internal information of the body of a patient. CT methods generally include X-ray computerized tomography, ultrasound tomography, impedance tomography, and computed radiography. The CT devices converts an analog-type image generated by an ordinary X-ray device into a digital signal. In general, of the films made in hospitals, 80% are ordinary X-ray films, 7% are CT films, and 5% are MRI films. Also in PACS systems, the amount of CR image processing connected to an ordinary X-ray system takes the largest share, i.e. 80%, of the entire image processing amount.

As an example, an X-ray CT will now be described. An X-ray tube is mounted on a support (not shown) and the support moves over a patient. In the opposite side of the tube, there are detectors (not shown) mounted on a fan-shape ring. The detectors record all rays penetrating a section of the patient's body. The detectors can simultaneously record about 500 through 1000 pieces of data. The structure and operating principle of the CT device are also well known to a person of ordinary skill in the art, and the structure of the CT device is not related to the present invention. Any CT device that can visualize and output the image of a predetermined part of the body of a patient may be employed. Therefore, a detailed explanation of the CT device will be omitted.

The image generating unit 110 may further include a digital conversion unit (not shown) for converting an analog signal into a digital signal. The digital conversion unit is not an essential part of the image generating unit 110, and is necessary only when the image is in the form of an analog signal. The reason for converting an analog signal into a digital signal is because it is needed to image-process, store, and transmit image information in the form of a digital signal.

Examples of devices using an analog picture signal include simple X-ray devices, fluoroscopy devices, and angiography devices. Since output image of these devices is in the form of an analog signal, the analog signal should be converted into a digital signal by a digital converter (not shown). Since the output image of a CT device, an MRI device, an ultrasound (US) device, a radiography inspection (RI) device, and a digital fluoroscopy device is a digital signal, a digital converter (not shown) is not needed. The digital output signal of the image generating unit 110 is digitally processed in the image processing unit 120.

In the image processing unit 120, the digital output signal of the image generating unit 110 may be compressed, or the size of the image, the contrast, and the resolution of the digital output signal may be adjusted. That is, the image processing unit 120 can scale up or down an image, adjust the direction of an image, and magnify a predetermined part of an image. In addition, the image processing unit 120 may perform calibration statistics of an image, filter the picture and emphasize a predetermined spatial frequency of the image, or may perform image processing jobs such as gradation processing and image synthesis. If the direction of an object is reversed, or the object is turned upside down during image acquisition, the image processing unit 120 can adjust the direction of the picture. Performing the calibration statistics of a picture means measuring the distance and angle between two pixels, the average area, and the standard deviation. Since the structure and operation of this digital image processing unit 120 is well-known to a person of ordinary skill in the art, a detailed explanation of the unit's structure and operation will be omitted.

Also, the image is processed in the image processing unit 120, using the look-up table 130. To diagnose a disease more accurately with the look-up table 130, a medical doctor can display and emphasize a given part of the image.

The look-up table 130 holds information on which pixels' values should be changed. Therefore, the image is changed through the look-up table 130. The operation for changing the image using the look-up table 130 will be explained later.

The control values of the look-up table 130 may be changed by a user. Therefore, a medical doctor can personally set a most preferable look-up table 130 with respect to a part of the body of a first patient. The look-up table 130 set by the medical doctor is stored in the storage module 135, and may be used later when the medical doctor analyzes the image of the same part of the body of a second patient. Therefore, by setting a most preferable look-up table with respect to a part of the body of a patient, and storing in advance the look-up table in the storage module 135, the medical doctor can use the look-up table and adaptively change it with respect to a part of a body.

The image is processed in the image processing unit 120 and output in the display unit 140. The display unit 140 is a quite important module through which the image is provided to a practitioner. Resolution is the most important factor in the display unit 140, and devices such as MRI and CT devices can display an obtained picture without changing it, because these devices output digital images. However, the image resolution of devices outputting analog images such as X-ray devices, exceeds the level of the current digital technologies, and cases where the resolution of an image should be appropriately adjusted may occur. For example, most image information have a normal resolution of 1000×1000 pixels, and high resolution image information needs 2000×2000 pixels. In particular, a mammograph may need 4000×4000 pixels.

It is preferable that the screen size of a monitor used for the display unit 140 is greater than 20 inches so that a plurality of pictures may be displayed on one screen. Though the brightness of a monitor is usually 20˜30 foot-Lamberts, too high brightness shortens the life of the monitor. Therefore, it is preferable that the brightness of the monitor is at least 60 foot-Lamberts when the current technology level is considered. Also, the 8 bit (256 levels) contrast resolution of the monitor is widely used. In order to accurately express all the information of a 10 bit (1024 levels) or 12 bit (4096 levels) picture using an 8 bit resolution monitor, the maximum number of bits which a monitor can allow, a window/level adjusting function for adjusting contrast and brightness in real-time may be needed. The window indicates the range of contrast which is desired to be displayed while the level is for adjusting the brightness of an entire picture.

The structure and operation of the display unit 140 is well-known to a person of ordinary skill in the art, and therefore a detailed explanation will be omitted.

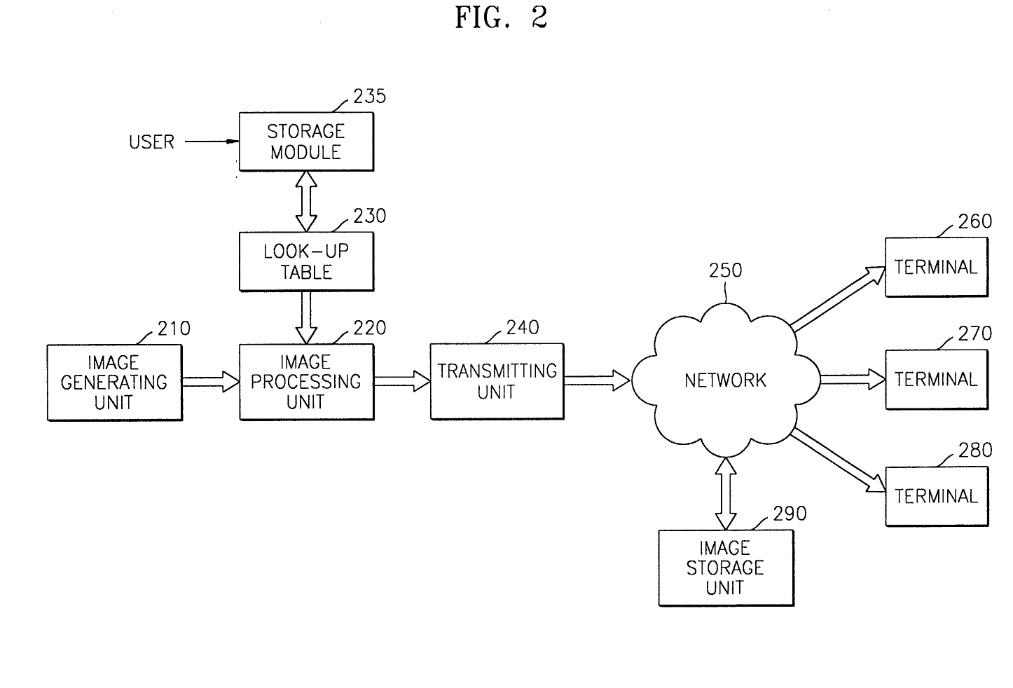

FIG. 2 is a block diagram of a medical picture archiving and communications system to which a medical image processing method according to the present invention is applied. The medical picture archiving and communications system of FIG. 2 has an image generating unit 210, an image processing unit 220, a look-up table 230, a table storage module 235, a transmitting unit 240, a network, one or more terminals 260 through 270, and an image storage unit 290.

Image generated in the image generating unit 210 is processed by the image processing unit 220. Using the look-up table 230, the image processing unit 220 processes the image, while the look-up table 230 can be adjusted by a user, as is explained referring to FIG. 1. Also, the look-up table 230 which can be adaptively modified with respect to a part of the body of a patient is stored in the table storage module 235, and can be used in analyzing the image corresponding to the same part of a body.

The image which is processed by the image processing unit 220 is transmitted to the network 250 by the transmitting unit 240. The network 250 may be a local area network (LAN) such as an intranet within a hospital, or a long-distance network such as the Internet. The structure of the network 250 is not a unique part of the present invention. Rather, any network 250 that can convey image information to one or more terminals 260 through 280 can be used. Images which are transmitted from the transmitting unit 240 are stored in the image storage unit 290. To implement the image storage unit 290, the following media may be used.

1) An image display memory: a high-speed data storage device is needed to display picture data on the monitor and to support real-time image processing. For this, a semiconductor memory may be used. As the data amount of image information for an examination is generally 5-20 Mbytes, a high-speed memory with about 40-60 Mbytes capacity is needed in order to compare and diagnose about 3 pieces of image information when the image is read.

2) A local disk: if the speed of the network is fast enough, picture data can be transmitted from a central storage device through the network whenever necessary. However, since a traffic jam may happen when requested data amount may suddenly increase, a local disk may be installed. It is preferable that the capacity of the local disk is greater than the amount (about 500-1000 Mbytes) which can be read in a day, and more than one local disks are processed in parallel to enable high-speed image processing.

3) A central storage unit: if the average hospitalization period of a patient is about one week, the medical images of the patient may be displayed frequently during this period; after that period the frequency of using the medical images will suddenly lower. Therefore, images of about one week old should be smoothly input and/or output. For example, in case of a university hospital having about 1,000 beds, about 200 Gbytes are needed. Sometimes, using a loss-less compression storage method having a 2:1 compression ratio, the amount of data to be stored is reduced by half. In this case, a program for restoring the original pictures in real time is needed. Reliability and speed are important in a central storage unit, and for this, it is preferable that a redundancy array of inexpensive disks (RAID) which enables parallel processing and error correction is used.

4) A permanent storage unit: by law medical images should be kept without damage for five years. In addition, the data should be available in a central storage unit and displayed whenever necessary. For this, it is preferable to use an optical disk jukebox. For example, since a university hospital having about 1,000 beds stores over 3 Tbytes picture data for one year, it is preferable to use a 10 1 loss-less compression and adequately store the compressed data.

As described above, since the structure of the image storage unit 290 is well-known to a person of ordinary skill in the art and is not within the technological scope of the present invention, detailed explanations will be omitted. In the picture archiving and communications system to which an image processing method of the present invention is applied, any storage media that can store image information can be used as the image storage unit 290.

In addition, though it is described in FIG. 2 that the image storage unit 290 is connected to the network 250, the present invention is not restricted to this, and image generated by the image generating unit 210 can be stored in any storage media.

Image information is transmitted through the network 250 to the terminals 260 through 280 and is displayed in the terminals 260 through 280. By manipulating the terminals 260 through 280, a practitioner receives medical images of a patient, and can diagnose the patient.

The structure of the picture archiving and communications system shown in FIG. 2 is not restrictive. For example, in FIG. 2, information generated in the image generating unit 210 is sent to the image processing unit 220, and then is transmitted to the terminals 260 through 280 through the network 250. However, the present invention is not restricted to this. The image may be first transmitted to the terminals 260 through 280 through the network 250 and then processed in the terminals 260 through 280 before being displayed. Rather, this method has an advantage in that a practitioner can obtain an optimal picture by manipulating the terminals 260 through 280 and thus diagnose the patient.

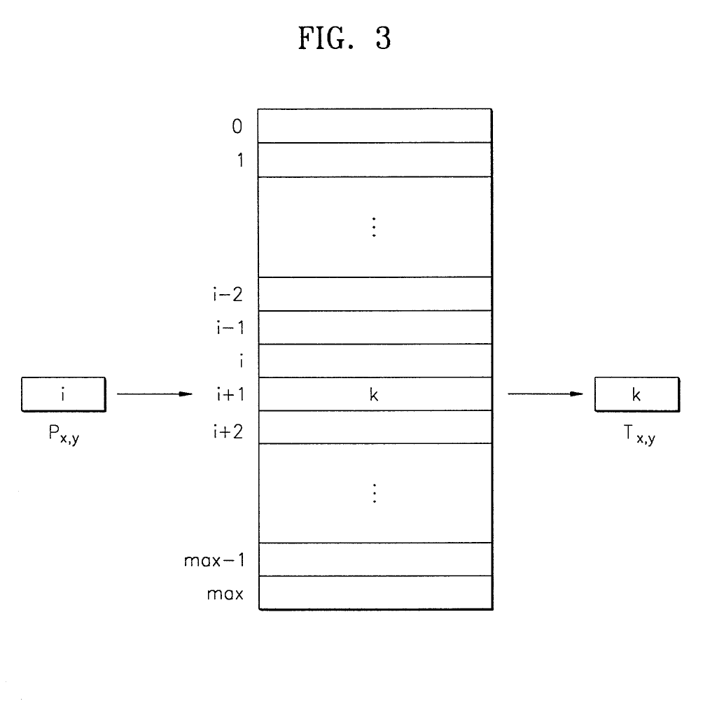

FIG. 3 is a diagram of a look-up table. A point processing algorithm for changing the values of picture elements forming the image is efficiently performed using the look-up table shown in FIG. 3. The look-up table uses the values of picture elements of the current image as indices of an array. By doing so, members of the look-up table indicated by an index are changed into a new picture element value.

Referring to FIG. 3, the look-up table consists of elements ranging from ‘0’ to ‘max’. Each element is indicated by picture element value (i) of P_{x,y} which represents the picture element before changing. If the picture element value P_{x,y} is i as shown in FIG. 3, then k is the value of i-th element of the look-up table set to the picture element value T_{x,y} which is a picture element after changing. This is shown in equation 1 as follows.

T_{x,y}=lut(P_{x,y}) (1)

Function lut(.) represents the array of a look-up table. The number of elements of the look-up table is the same as the number of all picture element values from an image. For example, in an image digitized by 8 bits, the number of elements of the look-up table is 256, while in an image digitized by 12 bits, the number of elements is 4096. Data of the look-up table is also referred to as a transfer function. For example, a transfer function to convert an image into a reversed image is given by equation 2:

f(x)=max−x (2)

where ‘max’ is the maximum value of a picture element value and ‘x’ denotes the current value of a picture element.

A transfer function to reduce the strength of the image is as presented in equation 3:

$$f ( x ) = \frac{x}{2} \qquad ( 3 )$$

Transfer functions such as those presented in equations 2 and 3 are represented by linear graphs. A look-up table having this transfer function is referred to as a linear transfer table.

If the linear look-up table is used, the entire image can be changed according to a predetermined rule. However, when it is desired to emphasize a predetermined part of a picture, it is necessary to use a non-linear look-up table. For example, for convenience of explanation, it is assumed that the picture element value of a diseased tissue of a living body is less than or equal to 5. Then, in a brain picture, the practitioner reduces the strength of a part of a picture, the part of which strength is less than or equal to 5, by half, and doubles the strength of a part of the picture, the part of which strength is greater than 5 such that the practitioner easily distinguish the diseased part from the remaining part. The transfer function of this look-up table is as follows

[Equation 4]

$$f ( x ) = \{ \begin{matrix}\frac{x}{2} & x < 5 \\ 2 x & x \geq 2\end{matrix} \qquad ( 4 )$$

Since the graph of the transfer function of equation 4 is non-linear, the look-up table for implementing this transfer function is referred to as a non-linear look-up table.

As another example, in a 3-bit digital image, a non-linear transfer function for changing a picture element value into 2 when the picture element value is less than or equal to 5, and changing a picture element value into 6 when the picture element value is greater than 5 is as follows.

[Equation 5]

$$f ( x ) = \{ \begin{matrix}2 & x < 5 \\ 6 & x \geq 5\end{matrix} \qquad ( 5 )$$

In addition, a look-up table for implementing equation 5 is as presented in Table 1.

TABLE 1

| Index | Value |
|---|---|
| 0 | 2 |
| 1 | 2 |
| 2 | 2 |
| 3 | 2 |
| 4 | 2 |
| 5 | 6 |
| 6 | 6 |
| 7 | 6 |

If the look-up table of FIG. 3 is used, only operations in units of points are performed, and this reduces the computational amount. By interactively modifying the look-up table, the practitioner can personally implement an optimal picture for diagnosis and store the modified look-up table so as to easily use the table later.

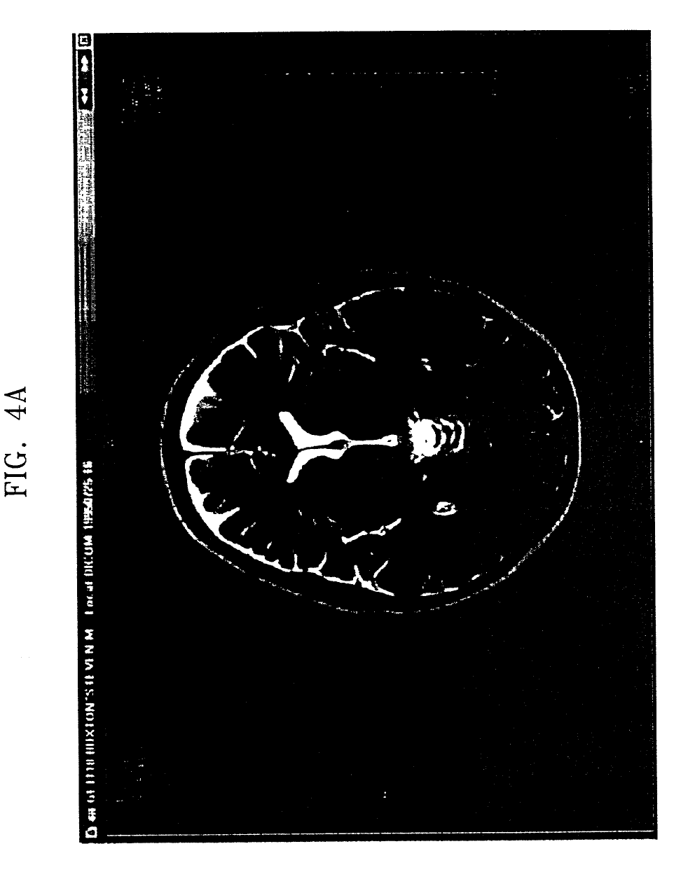

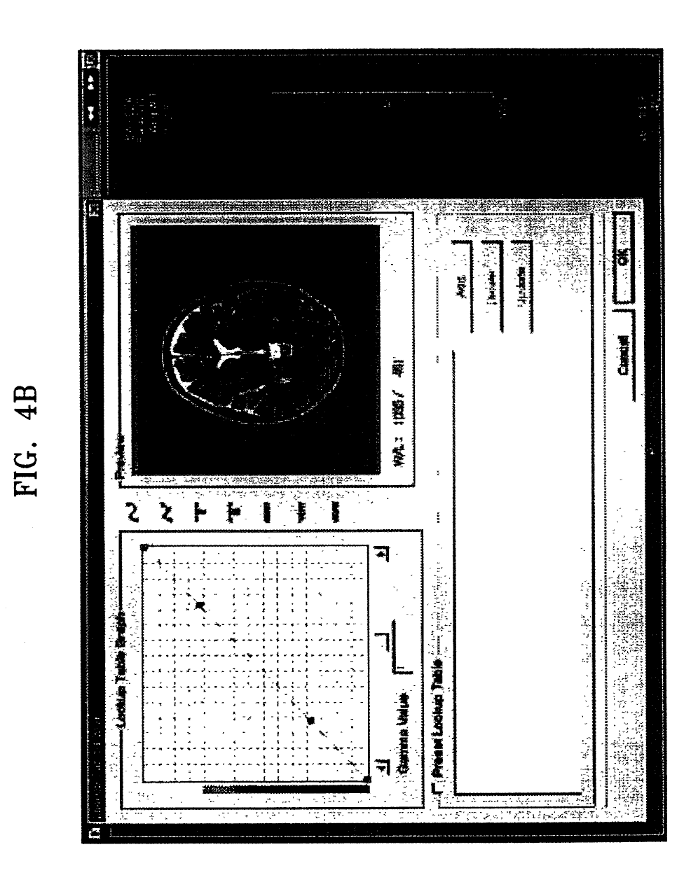

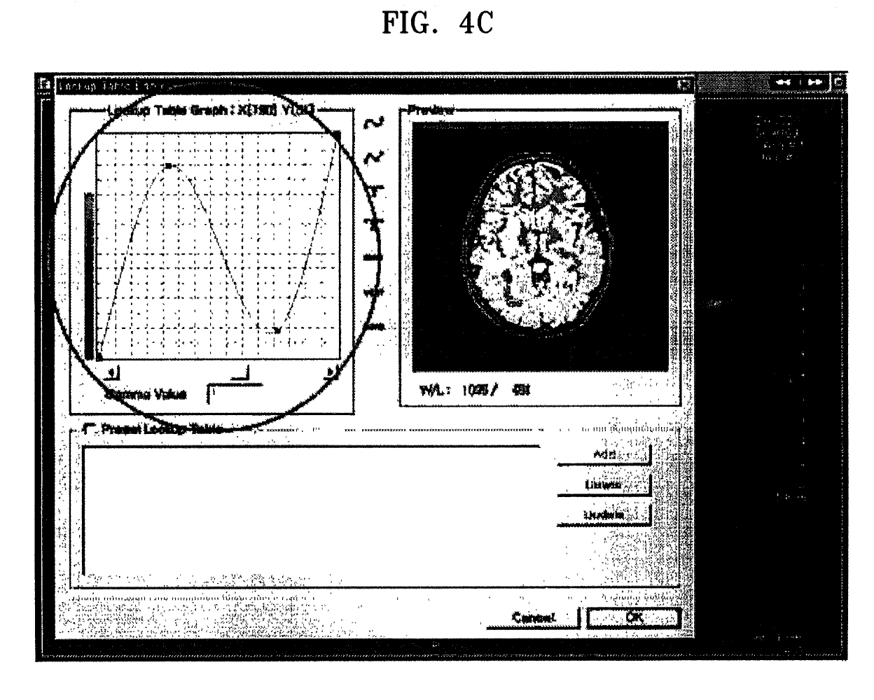

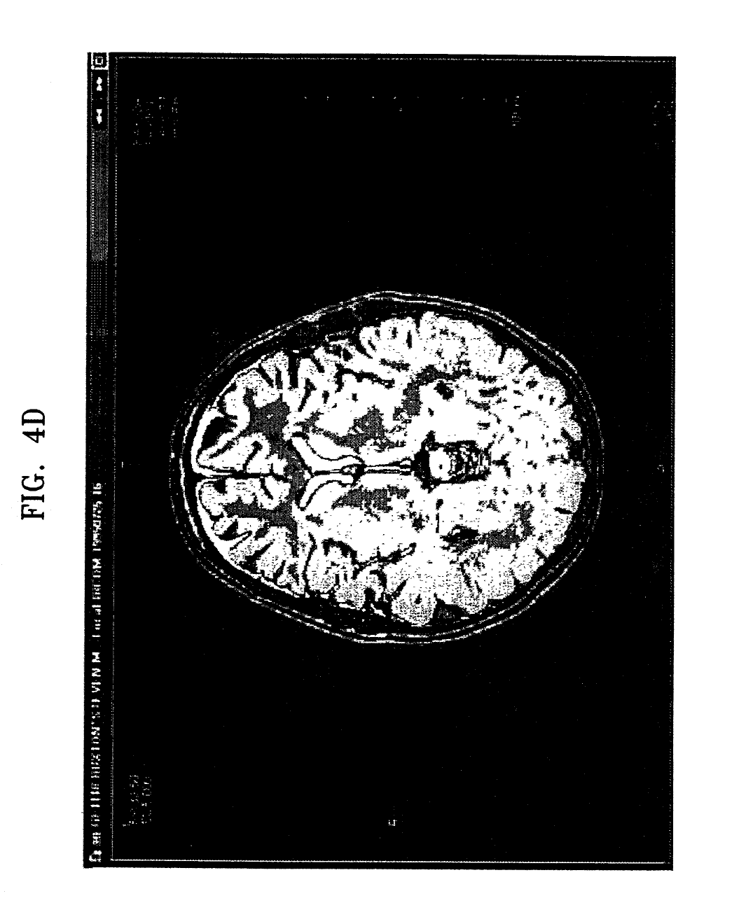

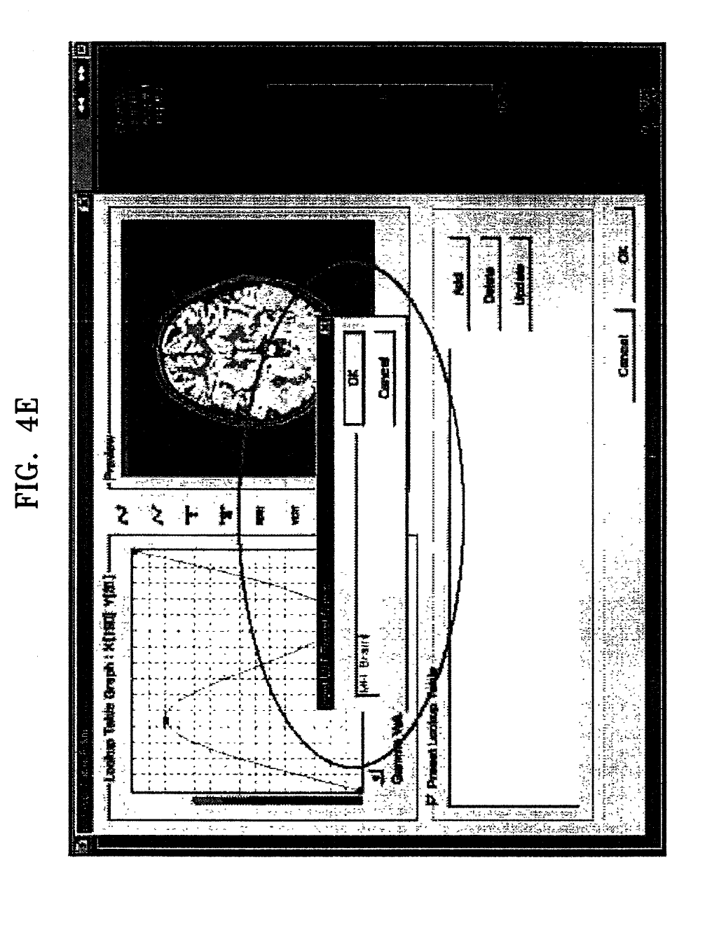

FIG. 4a is a transverse X brain picture which is displayed by a medical device of the present invention. Preferably, the display unit (refer to unit 140 of FIG. 1) of the medical device according to the present invention supports a graphic user interface so that a practitioner can easily manipulate the device. The user diagnoses a disease of a patient by inspecting the brain picture of the patient shown in FIG. 4a; during this process the practitioner may want to make the dark part of the picture of FIG. 4a be displayed brightly. Then, the practitioner refers to a look-up table used in displaying the current brain picture and modifies the picture as he/she wants.

FIG. 4b is a diagram of a look-up table used in displaying the brain picture shown in FIG. 4a. The graph of FIG. 4b shows a linear transfer function. Then, referring to the brain picture on the right-hand side of FIG. 4b, in order to obtain a picture appropriate for diagnosis, the practitioner can obtain a desired transfer function by moving points A and B. The practitioner may use an input device such as a keyboard so as to determine the locations of points A and B, or may use a mouse to move points A and B to desired locations so that transfer function is easily set to a new value.

FIG. 4c is a diagram of a modified look-up table of the look-up table of FIG. 4a. Referring to FIG. 4c, by moving points A and B, the transfer function is modified to an N shape, and the brain picture changed accordingly. In a real clinical diagnosis, this N-shaped curve is rarely used, because the performance of a display device used in displaying picture information is good enough to distinguish differences without largely modifying the look-up table. However, since differences can be distinguished only based on drawings in the present application, the transfer function is artificially largely modified in the drawings so as to be easily understood. The transfer function of FIG. 4c is just an example and is not used to restrict the present invention.

FIG. 4d is a diagram of the brain picture after the brain picture shown in FIG. 4a is converted using the look-up table shown in FIG. 4c. It is shown that the brain picture of FIG. 4d is clearly different from the original picture of FIG. 4a.

FIG. 4e is a diagram for explaining a function for storing the look-up table shown in FIG. 4c. When the most preferable use of the transfer function in reading the brain image of the patient is determined as in FIG. 4c, the practitioner can store the look-up table by this transfer function in the storage module (refer to 135 of FIG. 1). The practitioner may set look-up tables appropriate to each part of the patient's body and store the look-up tables under names that can be easily distinguished. Referring to FIG. 4e, a preferable look-up table to analyze this brain picture is stored under the name of MR-Brain.

The reason why a different look-up table is set preferably according to a part of the patient's body is that the histogram and strength of the image differs in each part of the body. For example, images obtained by photographing a wrist bone have a histogram different from that of an ankle bone. In addition, since an area in which a disease occurs is different in each part of a body, a different look-up table may be needed for each part of the body.

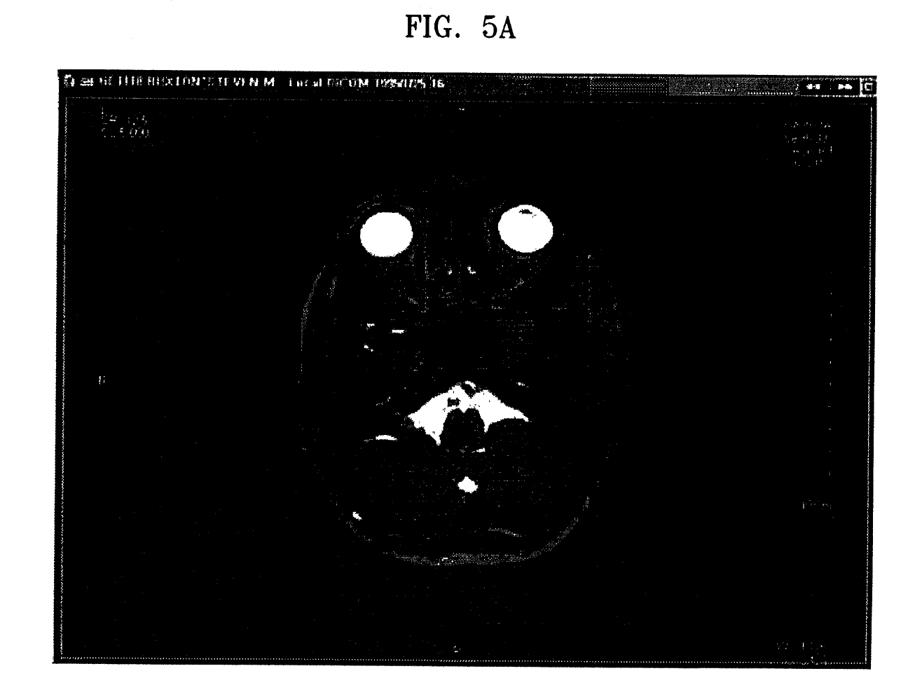

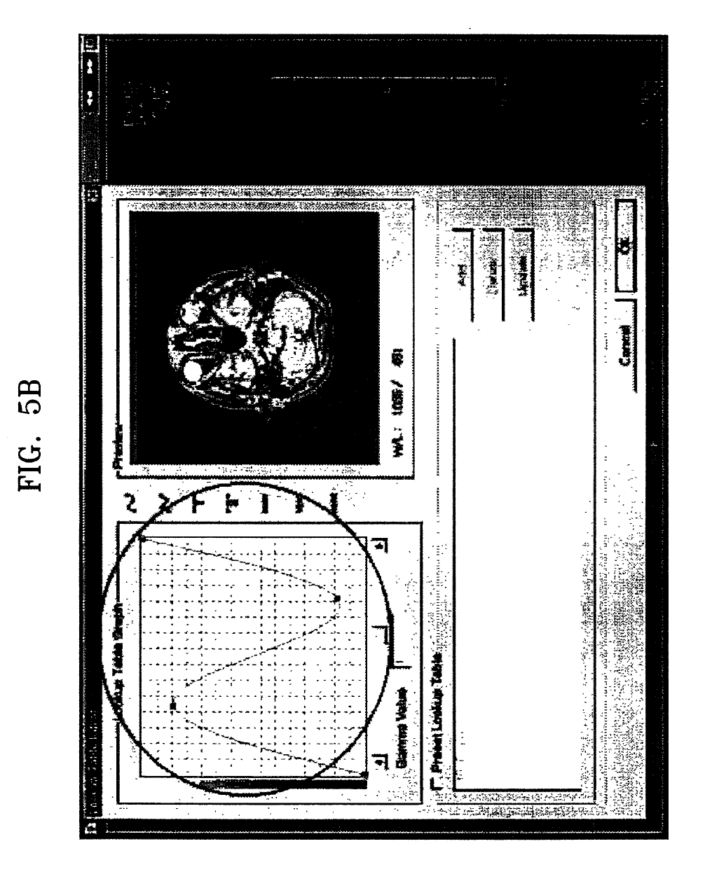

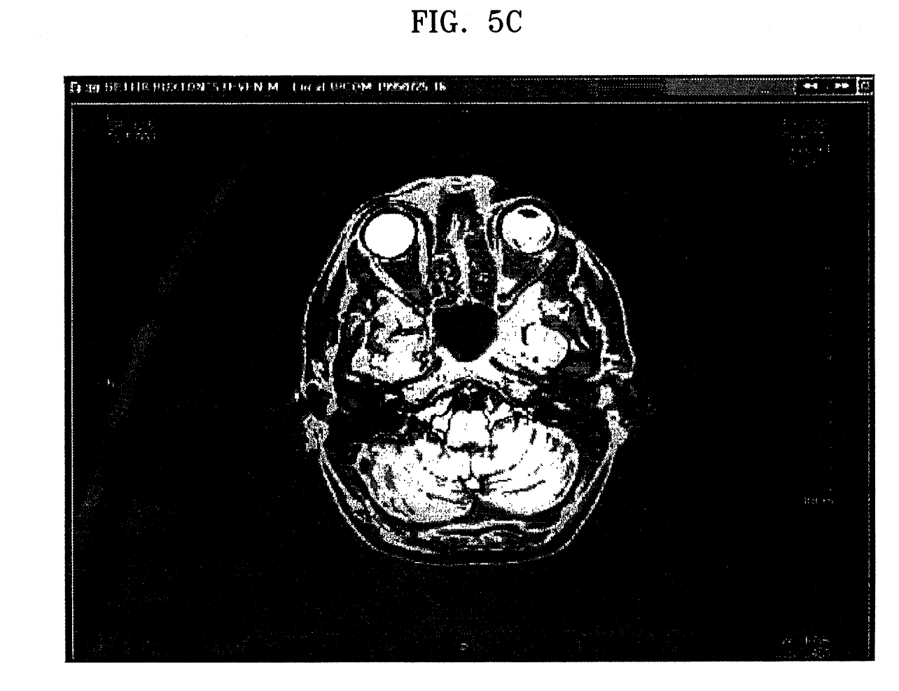

FIG. 5a shows another transverse X brain picture which is displayed by a medical device according to the present invention. The brain picture of FIG. 5a shows a brain part different from that of the brain picture of FIG. 4a. Here, if the practitioner analyzes the brain picture, the practitioner doesn't need to modify the look-up table again, because the look-up table is already stored under the name of MR_Brain as shown in FIG. 4e.

FIG. 5b is a diagram for explaining a function for fetching a look-up table stored in FIG. 4e in order to apply the look-up table to the brain picture of FIG. 5a. As shown in FIG. 5b, when reading the MR_Brain look-up table from the look-up tables stored in the storage module (refer to unit 135 of FIG. 1), the practitioner does not need to modify the look-up table again.

FIG. 5c shows a brain picture obtained by converting the brain picture shown in FIG. 5a using the look-up table stored in FIG. 4e. The brain picture of FIG. 5c is a picture obtained by converting the picture of FIG. 5a by applying the MR_Brain look-up table to the picture of FIG. 5a. The difference is easily seen with the naked eye.

So far, optimum embodiments are explained in the drawings and specifications, and though specific terminologies are used here, those were only to explain the present invention. For example, the user interface shown in FIGS. 4a through 5c is just an embodiment and the present invention is not restricted to this. In the described embodiments, the look-up table is modified and stored using an appropriate software. However, the present invention is not restricted to this, and any structures in which any look-up tables are modified, stored, and, when necessary, read, may be used.

Therefore, the scope of the present invention is not determined by the description but by the accompanying claims.

According to the present invention, a medical diagnostic device which improves the quality of medical images is provided.

Also, according to the present invention, an image processing method applied to a medical picture archiving and communications system is provided.

According to the present invention, a practitioner can personally modify a look-up table to obtain a desired picture, and a modified look-up table is stored to be used whenever necessary.

What is claimed is

1. A medical device for displaying medical images of a patient in order for a doctor to diagnose health condition of the patient, wherein the medical device non-linearly converts the values of the picture elements forming the medical image by practitioner's manipulation and displays the converted image.

2. The medical device of claim 1, wherein the medical device comprises:
an image generating unit which generates the medical image;
an image processing unit which receives the image signal, and processes the image to display the received signal; and
a display unit which receives the output signal of the image processing unit and displays the signal,
wherein the image processing unit changes the values of the picture elements forming the image using a look-up table of which element values change according to the practitioner's manipulation.

3. The medical device of claim 2, wherein the medical device further comprises:
a storage module which stores the look-up table adaptively modified according to each part of the patient's body,
wherein a look-up table stored corresponding to each part of the patient's body is read and the image is processed.

4. The medical device of claim 3, wherein the image is generated by a computed radiography (CR) device.

5. The medical device of claim 3, wherein the image is generated by a computed tomography (CT) device.

6. The medical device of claim 3, wherein the image is generated by a magnetic resonance imaging (MRI) device.

7. A medical image information processing method which is to be used in a medical picture archiving and communications system which stores medical images of a patient in a storage medium, and transmits the images to one or more terminals through a network, wherein the values of picture elements forming the images are non-linearly converted by manipulation of the doctor and then are displayed.

8. The method of claim 7, wherein the medical picture archiving and communications system comprises:
an image generating unit which generates the image;
a transmitting unit which transmits the image through a network; and
one or more terminals which receive and display the transmitted image,
wherein the image is displayed after the values of picture elements forming the image are changed using a look-up table of which member values change according to the practitioner's manipulation.

9. The method of claim 8, wherein the medical picture archiving and communications system further comprises a storage module which stores look-up tables adaptively modified according to each part of the patient's body and the look-up tables stored corresponding to the part of the patient's body are read and the image is processed.

10. The method of claim 9, wherein the image is generated by a computed radiography (CR) device.

11. The method of claim 9, wherein the image is generated by a computed tomography (CT) device.

12. The method of claim 9, wherein the image is generated by a magnetic resonance imaging (MRI) device.
